(19) United States
(12) Patent Application Publication
(10) Pub. No.: US 2021/0273523 A1
(43) Pub. Date: Sep. 2, 2021

(54) Driving Device for a Motor Vehicle, in Particular for a Car, and Motor Vehicle Having Such a Driving Device

(71) Applicant: Vitesco Technologies Germany GmbH, Hannover (DE)

(72) Inventors: Holger Fröhlich, München (DE); Isao Fukumoto, München (DE)

(73) Assignee: Vitesco Technologies Germany GmbH, Hannover (DE)

(21) Appl. No.: 17/276,805

(22) PCT Filed: Aug. 28, 2019
(86) PCT No.: PCT/EP2019/072978

§ 371 Date: Mar. 16, 2021

(30) Foreign Application Priority Data
Sep. 20, 2018 (DE) 10 2018 216 037.6

(51) Int. Cl. H02K 9/06; H02K 7/00; H02K 9/19; H02K 11/33

(52) U.S. Cl. CPC H02K 9/06; H02K 7/006; B60L 50/60; H02K 11/33; H02K 9/19

(57) ABSTRACT

Various embodiments include a driving device for a motor vehicle comprising: an electric machine with a stator and a rotor driven by the stator for propelling the motor vehicle; a blower wheel driven by the rotor to convey air for cooling at least a first portion of the electric machine; an electric component supplying the electric machine with electrical energy; and a heat exchanger downstream of the blower wheel transferring heat from a coolant to the air flowing around the heat exchanger.

### CROSS-REFERENCE TO RELATED APPLICATIONS

This application is a U.S. National Stage Application of International Application No. PCT/EP2019/072978 filed Aug. 28, 2019, which designates the United States of America, and claims priority to DE Application No. 10 2018 216 037.6 filed Sep. 20, 2018, the contents of which are hereby incorporated by reference in their entirety.

### TECHNICAL FIELD

The present disclosure relates to motor vehicles. Various embodiments may include driving devices for a motor vehicle, in particular for a car, and/or motor vehicles, in particular a car.

### BACKGROUND

DE 10 2010 026 682 A1 describes an electric machine, having a rotor and having a stator with a circumferentially arranged stator winding made of an electrically conductive material. In addition, a housing is provided with a first and a second opening extending in the circumferential direction, with a blower being arranged on the end face of the rotor.

EP 0 418 027 B1 describes a fan for a rotating electric machine. The fan includes a rotatable shaft and a rotor connected to the shaft. In addition, a ventilated housing is provided for accommodating the shaft and the rotor.

EP 1 627 458 B1 describes a rotating electric machine. The electric machine comprises a housing which is provided with at least one front bearing and with a rear bearing. A stator on which at least one stator winding is seated is arranged in the interior of the housing.

EP 1 929 611 B1 discloses a ventilation system for a rotary electric machine.

### SUMMARY

The teachings of the present disclosure include driving devices for a motor vehicle and motor vehicles for a particularly high performance particularly favorable in terms of construction space. For example, some embodiments of the teachings herein include a driving device (10) for a motor vehicle, having at least one electric machine (12) which has a stator (16) and a rotor (18), which can be driven by the stator (16) and can thereby be rotated relative to the stator (16), for driving the motor vehicle, and having at least one blower wheel (26) which can be driven by the rotor (18) and by means of which, by driving the blower wheel (26), it is possible for air to be conveyed for cooling at least a partial region (T1, T2) of the electric machine (12), characterized by at least one electric component (32) via which the electric machine (12) can be supplied with electrical energy; and at least one heat exchanger (36), around which the air conveyed by means of the blower wheel (26) can flow and through which a coolant to be cooled via the heat exchanger (36) by means of the air flowing around the heat exchanger (36) can flow, by means of which it is possible for the electric component (32) to be cooled.

In some embodiments, the heat exchanger (36) is arranged in a closed cooling circuit (38) through which the coolant can flow.

In some embodiments, there is at least one conveying element (40) for conveying the coolant.

In some embodiments, the conveying element (40) is arranged within the heat exchanger (36).

In some embodiments, for conveying the coolant, the conveying element (40) can be driven by the rotor (18) without contact by means of magnetic forces and can thereby be rotated about an axis of rotation (20) relative to the heat exchanger (36).

In some embodiments, there is at least one magnet (42) connected to the rotor (18) for rotation therewith, in particular permanent magnet, by means of which the magnetic forces for driving the conveying element (40) can be provided.

In some embodiments, the heat exchanger (36) is in direct contact with a housing (34) of the component (32).

In some embodiments, there is at least one contact element (44) which is formed separately from the electric component (32) and separately from the heat exchanger (36), is provided in addition to the heat exchanger (36) and in addition to the electric component (32) and is in direct contact with the heat exchanger (36) and with a housing (34) of the electric component (32).

In some embodiments, the heat exchanger (36) is in direct contact with a bearing plate (24) on which the rotor (18) is rotatably mounted.

In some embodiments, the blower wheel (26) is designed as a radial blower wheel.

In some embodiments, the coolant comprises at least water, in particular distilled water, and/or at least one oil and/or at least one alcohol, in particular glycol.

In some embodiments, the electric component (32) is configured as a power converter (32).

As another example, some embodiments include a motor vehicle, having at least one driving device (10) which has: at least one electric machine (12) which has a stator (16) and a rotor (18), which can be driven by the stator (16) and can thereby be rotated relative to the stator (16), for driving the motor vehicle; and at least one blower wheel (26) which can be driven by the rotor (18) and by means of which, by driving the blower wheel (26), it is possible for air to be conveyed for cooling at least a partial region (T1, T2) of the electric machine (12), characterized by at least one electric component (32) via which the electric machine (12) can be supplied with electrical energy; and at least one heat exchanger (36), around which the air conveyed by means of the blower wheel (26) can flow and through which a coolant to be cooled via the heat exchanger (36) by means of the air flowing around the heat exchanger (36) can flow, by means of which it is possible for the electric component (32) to be cooled.

### BRIEF DESCRIPTION OF THE DRAWINGS

Further advantages, features, and details of the teachings herein will emerge from the following description of an exemplary embodiment and with reference to the drawing. The features and combinations of features mentioned in the description above and the features and combinations of features mentioned in the description of the figures below and/or shown in the figures alone can be used not only in the respectively stated combination, but also in other combinations or alone without departing from the scope of the disclosure.

In the drawing:

FIG. 1 shows a schematic illustration of a driving device incorporating teachings of the present disclosure for a motor vehicle;

FIG. 2 shows a schematic exploded view of the driving device;

FIG. 3 shows a schematic and sectional side view of the driving device;

FIG. 4 shows part of a schematic and sectional side view of the driving device;

FIG. 5 shows a schematic sectional view of a heat exchanger of the driving device; and

FIG. 6 shows a schematic top view of a contact element of the driving device.

In the figures, identical, or functionally identical elements are provided with identical reference signs.

### DETAILED DESCRIPTION

The teachings of the present disclosure relate to motor vehicles. Various embodiments include driving devices for a motor vehicle. The driving device comprises at least one electric machine by means of which the motor vehicle can be driven, in particular electrically. The motor vehicle is thus designed, for example, as a hybrid vehicle or as an electric vehicle, in particular as a battery electric vehicle (BEV). The electric machine has at least one stator and at least one rotor, which can be driven by the stator and can thereby be rotated about a machine axis of rotation relative to the stator. Via the rotor, the electric machine can, for example, provide torques for, in particular electrically, driving the motor vehicle. For example, at least one wheel or a plurality of wheels of the motor vehicle can be driven by means of the torques.

In some embodiments, the electric machine has at least one blower wheel which can be driven by the rotor and by means of which, by driving the blower wheel, it is possible for air to be conveyed, that is air can be conveyed, for cooling at least a partial region of the electric machine. The blower wheel can be rotated relative to the stator, for example, by driving the blower wheel about an axis of rotation of the blower wheel. The axis of rotation of the blower wheel coincides, for example, in the axis of rotation of the machine such that, for example, the blower wheel is arranged coaxially with respect to the rotor. In particular, it is conceivable for the blower wheel to be connected to the rotor for rotation therewith, in particular to a rotor shaft of the rotor for rotation therewith, and therefore, whenever the rotor is driven by the stator and thereby rotated about the axis of rotation of the machine, the blower wheel is rotated about the axis of rotation of the blower wheel relative to the stator. As a result, air is conveyed by means of the blower wheel. At least the partial region of the electric machine is cooled by means of the air.

In order now to be able to realize a high performance in a manner that is favorable in terms of construction space, the driving device has at least one electric component via which the electric machine can be supplied with electrical energy or electric current. The electric component is therefore a power electronics unit or part of a power electronics unit via which the electric machine can be supplied with electrical energy. By supplying the electric machine with electrical energy, the electric machine can be operated, for example, in a motor mode and thus as an electric motor by means of which the motor vehicle can be driven. In the motor mode, the rotor is driven by the stator.

In some embodiments, the driving device comprises at least one heat exchanger, around which the air conveyed by means of the blower wheel can flow. In other words, if the air is conveyed by means of the blower wheel, the air flows, for example, through the partial region, or the air flows around the partial region, as a result of which at least the partial region of the electric machine is cooled by means of the air. In addition, the air which is conveyed by means of the blower wheel flows around the heat exchanger such that, for example, heat can be or is transferred from the heat exchanger to the air flowing around the heat exchanger.

A coolant can also flow through the heat exchanger, with it being possible for the coolant to be cooled, that is to say it can be cooled, via the heat exchanger by means of the air flowing around the heat exchanger. For this purpose, for example, heat is transferred from the coolant flowing through the heat exchanger to the heat exchanger, and the previously described transfer from the heat exchanger to the air flowing around the heat exchanger takes place, as a result of which the coolant is cooled or can be cooled via the heat exchanger by means of the air flowing around the heat exchanger. It is possible for the electric component to be cooled by means of the coolant. Thus, for example, heat can be transferred from the electric component to the coolant, as a result of which the electric component is cooled by means of the coolant and ultimately by means of the air. In this way, the electric machine can be cooled particularly efficiently, effectively and in a manner that is favorable in terms of construction space, thus making it possible for a particularly high performance of the electric machine and thus of the driving device as a whole to be produced in a manner that is favorable in terms of construction space.

The coolant can, for example, flow directly onto and/or around at least a part of the component and can therefore be directly in contact therewith such that an efficient and advantageous transfer of heat from the component to the coolant can be realized. Furthermore, it is conceivable for a heat transfer medium to be provided through which the coolant can flow. The heat transfer medium is, for example, a constituent which is formed separately from the component and/or separately from the heat exchanger and is provided in addition to the heat exchanger and/or in addition to the component, wherein the component can be cooled via the heat transfer medium by means of the coolant. For this purpose, for example, heat is transferred from the component to the heat transfer medium, in particular conductively. In addition, heat is transferred from the heat transfer medium to the coolant.

In some embodiments, the driving device, in particular the electric machine, has, for example, at least one or precisely one air path through which the air conveyed or to be conveyed by means of the blower wheel can flow. This means that the air flows through the air path when the air is conveyed by means of the blower wheel. At least the partial region and the heat exchanger are arranged in the air path. For example, the partial region is arranged upstream or else downstream of the heat exchanger with respect to a direction of flow of the air flowing through the air path. In some embodiments, the heat exchanger is arranged upstream of the partial region in order to be able to particularly effectively and efficiently cool the electric component.

In some embodiments, air cooling of the electric machine is combined with liquid cooling of the electric component. On the one hand, the number of parts, the costs, the weight, and the construction space requirement of the driving device can thereby be kept particularly low. On the other hand, excessive temperatures of both the partial region or the electric machine and the electric component can be avoided, and therefore a particularly high performance can be produced.

In some embodiments, modern vehicles, in particular electric vehicles, are equipped with electric motors or electric motor arrangements and can be driven by means of the electric motor arrangements. The respective electric motor arrangement comprises, for example, at least one or precisely one electric machine for, in particular electrically, driving the respective vehicle. In addition, the respective electric motor arrangement usually comprises a power electronics unit for providing electric phase currents for the respective electric machine. The respective electric machine can thus be supplied with the electric phase currents via the respective power electronics unit. Due to the physical properties of the respective electric machine and the power electronics unit, power losses occur in the electric machine and in the power electronics unit during operation of the respective electric motor arrangement, wherein the power losses in the form of waste heat can lead to a temperature increase in the electric motor arrangement. A high intrinsic temperature of the respective electric motor arrangement can lead to a loss of power in the electric machine and, in extreme cases, even to a failure of the power electronics unit.

In order to avoid this, the waste heat must be dissipated during operation of the electric motor arrangement before the waste heat can cause damage in the electric motor arrangement. Such a heat dissipation can be realized in the driving device incorporating teachings of the present disclosure in a manner that is particularly favorable in terms of construction space and in a particularly efficient and effective manner. In other words, the combination of air cooling and coolant cooling described above enables effective and efficient dissipation of waste heat.

Usually either pure air cooling or pure coolant cooling is provided. In contrast thereto, in the case of the driving device, a combination of air cooling and coolant cooling is provided since at least the partial region of the electric machine is cooled by means of air and the electric component is cooled by means of the coolant. In this way, efficient cooling both of the electric machine and of the electric component can be realized while simultaneously requiring particularly little space. The electric machine may be an electric asynchronous machine or as an electric synchronous machine.

In some embodiments, the heat exchanger is arranged in a closed cooling circuit through which the coolant can flow. In this way, particularly effective and efficient cooling can be ensured in a manner that is favorable in terms of construction space. To be able to dissipate a particularly high amount of heat from the heat exchanger and thus from the electric component within a short time, in some embodiments, that the driving device has at least one conveying element for conveying the coolant. The conveying element may be arranged in the aforementioned cooling circuit. By driving the conveying element, the coolant can be conveyed through the cooling circuit and thus through the heat exchanger by means of the conveying element.

In order to be able to ensure particularly effective and efficient heat dissipation, in some embodiments, the conveying element is arranged, in particular at least partially or at least predominantly or completely, within the heat exchanger.

In some embodiments, in order to be able to drive the conveying element in a particularly simple and cost-effective manner and favorably in terms of construction space and, consequently, to be able to ensure effective and efficient cooling, for conveying the coolant, the conveying element can be driven by the rotor without contact by means of magnetic forces and can thereby be rotated about an axis of rotation, also referred to as axis of rotation of the conveying element, relative to the heat exchanger. The axis of rotation of the conveying element preferably coincides with the axis of rotation of the machine and/or with the axis of rotation of the blower wheel, such that the conveying element is arranged, for example, coaxially with respect to the rotor and/or coaxially with respect to the blower wheel.

In some embodiments, the driving device has at least one or precisely one magnet connected to the rotor, in particular to the rotor shaft, for rotation therewith, by means of which the magnetic forces for driving the conveying element can be provided or are provided. The magnet may be a permanent magnet. In some embodiments, the magnet is a ring magnet. The magnet is, for example, connected to the rotor, in particular to the rotor shaft, for rotation therewith. In particular whenever the magnet is designed as a ring magnet, the magnet is arranged, for example, on the rotor shaft, as a result of which the requirement for construction space, in particular in the axial direction of the electric machine, can be kept particularly low.

In some embodiments, the magnet provides the magnetic forces. The conveying element is designed to interact with the magnetic forces provided by the magnet, as a result of which, whenever the rotor, in particular the rotor shaft, and thus the magnet, are driven and thus rotated, in particular about the axis of rotation of the machine, relative to the stator, the conveying element is driven by means of the magnetic forces. The conveying element is therefore driven magnetically in the manner of a stirring bar known from chemistry without a mechanical connection being provided between the conveying element and the rotor. The feature that the conveying element can be driven by the rotor without contact by means of the magnetic forces is to be understood as meaning that the conveying element can be driven without contact, at least in relation to the conveying element and the rotor. In some embodiments, the conveying element can be driven by the rotor by means of the magnetic forces without the rotor being in contact with the conveying element, that is to say without the conveying element being mechanically coupled to the rotor.

By the conveying element being able to be driven without contact, said conveying element can be arranged within the heat exchanger in a particularly simple and cost-effective manner and favorably in terms of construction space and can be driven by the rotor arranged outside the heat exchanger without sealing measures that are intensive in terms of construction space and costs being required.

In some embodiments, in order to realize particularly effective and efficient cooling in a manner that is favorable in terms of construction space, the heat exchanger is in direct contact with a housing of the electric component. In this way, for example, particularly effective and efficient heat dissipation from the electric component can be realized, since, for example, heat can be transferred directly to the heat exchanger by conduction from the housing.

In some embodiments, the driving device has at least one contact element which is formed separately from the electric component and separately from the heat exchanger, is provided in addition to the heat exchanger and in addition to the electric component and is in direct contact with the heat exchanger and with the housing of the electric component. The heat exchanger is thus coupled in a heat-transferring manner to the housing by the contact element, which is designed, for example, as a contact plate, and therefore the heat exchanger is not in direct contact with the housing.

In some embodiments, the heat exchanger is in direct contact with the housing of the component, the heat exchanger is coupled in a heat-transferring manner to the housing directly, i.e. without using an additional element, and therefore the requirement for construction space and the number of parts can be kept particularly low. The thermal coupling of the heat exchanger to the housing via the contact element additionally provided for this purpose, however, enables a particularly large and therefore particularly advantageous, heat-transferring coupling of the heat exchanger to the housing via the contact element, such that a particularly large amount of heat can be transported away from the component within a short time.

In some embodiments, the heat exchanger or the contact element is in contact with at least a predominant part of a surface of the housing facing the heat exchanger or the contact element, with it being provided that the heat exchanger or the contact element is in contact with the entire surface of the housing facing the heat exchanger or the contact element. In some embodiments, the contact element is in contact with at least a predominant part of a surface of the heat exchanger facing the contact element. The contact element may be in contact with the entire surface of the heat exchanger facing the contact element. In this way, particularly efficient and effective cooling can be ensured.

In some embodiments, the heat exchanger is in direct contact with a bearing plate on which the rotor is rotatably mounted. As a result, heat can be transferred from the heat exchanger to the bearing plate, for example by means of conduction, and therefore particularly effective and efficient cooling can be produced in a space-saving manner.

In some embodiments, in order to be able to keep the requirement for construction space particularly low, the blower wheel is a radial blower wheel. In other words, the blower wheel forms a pump which is designed as a radial pump and by means of which the air can be conveyed. If the blower wheel is designed as a radial blower wheel, the air flows from the blower wheel in the radial direction of the blower wheel when the air is conveyed by means of the blower wheel. For example, if the air, when conveyed by means of the blower wheel, flows toward the blower wheel in the axial direction of the blower wheel, it is then deflected, for example, such that the air then flows away from the blower wheel in the radial direction of the blower wheel. The requirement for construction space can thereby be kept particularly low.

In some embodiments, the coolant comprises at least water, in particular distilled water. This allows a particularly large amount of heat to be removed within a short time. In some embodiments, the coolant comprises at least one oil and/or at least one alcohol, in particular glycol. In some embodiments, the coolant is formed at least almost completely from water or oil. By the coolant being in the form of an oil, undesirable electrical conductivity of the coolant can be avoided. The aforementioned alcohol, in particular the glycol, is an additive which, for example, can prevent the coolant from freezing undesirably early at low ambient temperatures.

In some embodiments, the electric component is a power converter, in particular as an inverter. In particular electric components, such as power converters, can become particularly hot during operation of electric machines, and therefore coolant cooling of such a power converter is particularly advantageous in order to be able to ensure a particularly high performance in a manner that is favorable in terms of construction space.

In some embodiments, there is a motor vehicle, in particular a passenger car. The motor vehicle has at least one or precisely one driving device, in particular at least one or precisely one driving device as described above according to the first aspect of the invention. The driving device has at least one electric machine for, in particular electrically, driving the motor vehicle. The electric machine comprises a stator and a rotor, which can be driven by the stator and can thereby be rotated relative to the stator. In addition, the driving device comprises at least one blower wheel which can be driven by the rotor and by means of which, by driving the blower wheel, it is possible for air to be conveyed for cooling at least a partial region of the electric machine.

In some embodiments, the driving device has at least one electric component which is assigned in particular to the electric machine and via which the electric machine can be supplied with electrical energy. In some embodiments, there is at least one heat exchanger, around which the air conveyed by means of the blower wheel can flow and through which a coolant to be cooled via the heat exchanger by means of the air flowing around the heat exchanger can flow, by means of which it is possible for the electric component to be cooled. Advantages and advantageous refinements of the devices are regarded as advantages and advantageous refinements of the methods described herein, and vice versa.

In some embodiments, the electric machine is a high-voltage component, the electric voltage, in particular the electric operating voltage, of which is greater than 12 volts (V) and, for example, is at least 48 V or greater than 48 V, in particular greater than 50 V. The electric voltage, in particular the electric operating voltage, may be several hundred volts in order to be able to realize particularly high electrical powers for electrically driving the motor vehicle.

In the case of air cooling, use can be made of a simple principle. A heat sink formed, for example, from a metallic material is in contact with a surface to be cooled, for example a surface of an electronic part of a power converter designed in particular as an inverter. Heat that develops in the electronic part is largely absorbed by the heat sink so that the parts do not overheat. It can thus be provided that the electric component is designed as an electronic part. The heat is then distributed in the material of the heat sink, also known as a cooler. The heat can then be released to the surrounding air at side surfaces. As a rule, a blower is then still used to set the air in motion so that the warm air can migrate and new, cooler air can be brought in. In order to increase the cooling performance, use is made as a rule of a type of base which has direct contact with the parts to be cooled, and the actual heat sink, which can have, for example, numerous slats and/or cooling fins, is placed on said base.

In this way, an extremely large heat sink surface can be created in a relatively small space. This is more efficient in particular compared to the use of a solid block. By using cooling fins, a large area can be created that has contact with the air without changing the basic dimensions of the heat sink. The more surface there is, the more heat can potentially be given off into the air. Such air cooling can be realized cost-effectively. The principle of coolant cooling, also referred to as water cooling, is based on the fact that the heat is transported away, for example, via a cooling circuit, also referred to as a coolant circuit, in particular via a water circuit. A pump can ensure that the coolant, embodied, for example, as water or at least or exclusively comprising water, reaches at least one heat sink which is fastened to the part to be cooled. The water absorbs heat from the part or from the heat sink and then flows on to the heat exchanger.

The heat exchanger absorbs the heat from the coolant, which is embodied, for example, as water, and which has previously picked up the heat from the part actually to be cooled. The water then flows back toward the pump and reaches the heat sink again. The circuit is then completed or closed. The heat exchanger releases the heat that it has taken from the water in turn to air, in particular to ambient air. It is usually assisted by one or more blowers since the heat around the heat exchanger ultimately has to be conveyed away. The combination of air cooling with coolant cooling that is provided according to the invention enables effective and efficient cooling of the driving device to be produced in a manner that is favorable in terms of construction space and cost-effective.

With conventional air cooling, the electronic components, in particular a power converter, heat a sufficiently dimensioned heat sink with a large surface in the form of cooling fins. A fan blows a stream of air over said surface to dissipate the heat as quickly as possible. Air is available in unlimited quantities in everyday surroundings and can be easily supplied and removed using the fan. Compared to air, a coolant, such as water, has a particularly high heat capacity and can therefore absorb more thermal energy than the same amount of air. For example, to heat 1 liter of water by 1° C., 4180 J are required. In order to absorb the same energy with air, 1.18 m³ of air is already required, which has to be conveyed by means of a blower or a fan.

In some embodiments, the heat exchanger provides an interface to the electric component. The heat exchanger is, for example, well ventilated outside the housing of the component in the air path, also referred to as the stream of air, through which the air conveyed by means of the blower wheel can flow. As a result, heat can be transferred from the coolant to the heat exchanger and from the heat exchanger to the air.

For example, in order to be able to cool the electric component with the coolant, the coolant flows, for example, at least through part of the electric component, and therefore heat can pass from the electric component to the coolant. In some embodiments, at least one heat transfer medium through which the coolant can flow to be provided, which is connected at least indirectly, in particular directly, in a heat-transferring manner to the electric component, in particular to the housing, and through which the coolant can flow. Thus, for example, heat can pass from the electric component, to the heat transfer medium and from the heat transfer medium to the coolant, as a result of which the electric component is cooled and the coolant is heated. The heated coolant can then flow to and through the heat exchanger. Then heat can pass from the coolant to the heat exchanger and from the heat exchanger to the air flowing around the heat exchanger, as a result of which the coolant can be cooled. As a result, it is possible to ensure particularly effective and efficient cooling of the component in a manner that is favorable in terms of construction space and is cost-effective.

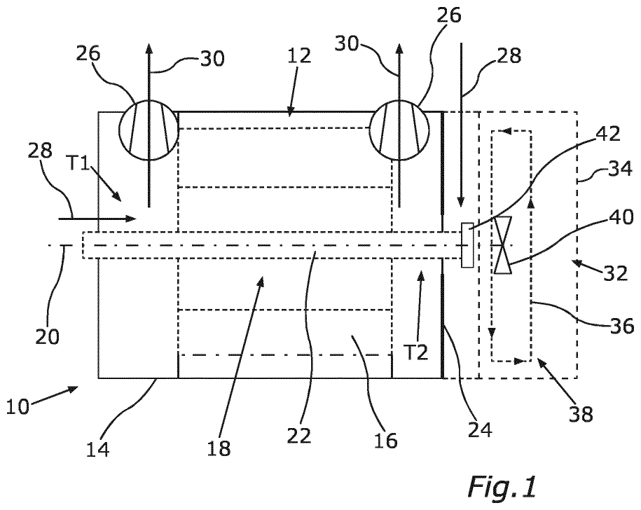

FIG. 1 shows a schematic illustration of a driving device 10 for a motor vehicle which can be a car and in particular a passenger car. The motor vehicle can be driven electrically by means of the driving device 10, and therefore the motor vehicle is designed as a hybrid or electric vehicle, for example. The driving device 10 has at least one or precisely one electric machine 12 which can be operated in a motor mode and thus as an electric motor. In order to operate the electric machine 12 in the motor mode, the electric machine 12 is supplied with electrical energy or with electric current. For this purpose, the motor vehicle has, for example, an energy store for storing electrical energy, wherein the electric machine 12 can be supplied with electrical energy that is stored in the energy store. The energy store and the electric machine 12 are designed as high-voltage components, the respective electric voltage, in particular electric operating voltage, of which is greater than 50 V and is several 100 V. In this way, particularly high electrical powers can be realized for electrically driving the motor vehicle.

The electric machine 12 has a housing which is also referred to as a machine housing 14 and in which a stator 16 and a rotor 18 of the electric machine 12 are accommodated. The rotor 18 can be driven by the stator 16 and can thereby be rotated about an axis of rotation 20 of the machine relative to the stator 16 and relative to the machine housing 14. The rotor 18 has a rotor shaft 22 which can be rotated about the axis of rotation 20 of the machine relative to the stator 16 and relative to the machine housing 14. Via the rotor 18, in particular via the rotor shaft 22, the electric machine 12 in its motor mode can provide at least one torque, by means of which the motor vehicle can be driven, in particular electrically.

The electric machine 12 also has at least one bearing plate 24. The bearing plate 24 can be formed integrally with the machine housing 14, or else the bearing plate 24 is a component which is connected separately from the machine housing 14 and, for example, at least indirectly, in particular directly, to the machine housing and can be at least partially, in particular at least predominantly and completely, arranged in the machine housing 14. The rotor 18 is mounted rotatably on the bearing plate 24 and, via the bearing plate 24, rotatably on the machine housing 14.

The driving device 10 also has blower wheels 26 which are designed here as radial blower wheels. The respective blower wheel 26 can be driven by the rotor 18 and, for this purpose, is connected to the rotor 18, in particular for rotation therewith, and therefore the respective blower wheel 26 can be rotated or is rotated about the axis of rotation 20 of the machine relative to the stator 16 and relative to the machine housing 14 when the rotor 18 is driven by the stator 16. It is possible to convey air by driving the respective blower wheel 26. In other words, if the respective blower wheel 26 is driven and is thereby rotated about the axis of rotation 20 of the machine relative to the machine housing 14, air is conveyed by means of the respective blower wheel 26. In FIG. 1, arrows 28 illustrate the air that is conveyed by means of the blower wheels 26. In other words, the arrows 28 illustrate a respective stream of air which is conveyed, that is to say, brought about, for example, by means of the respective blower wheel 26. The respective blower wheel 26 sucks in the air or the stream of air, in particular via a respective intake mouth of the driving device 10.

The respective blower wheel 26 thus functions as a fan or as a pump, by means of which fan or pump the air is conveyed. Since the respective blower wheel 26 is designed, for example, as a radial blower wheel, the fan is a radial fan or the pump is a radial pump. The air conveyed by means of the respective blower wheel 26 flows off the respective blower wheel 26 in the radial direction of the blower wheel 26, this being illustrated in FIG. 1 by arrows 30.

In order now to be able to realize a particularly high performance of the driving device 10 in a manner that is particularly favorable in terms of construction space, the driving device 10 has at least one electric component which is designed here as a power converter 32 and may be an electronic component. Via the power converter 32 designed, for example, as an inverter, the electric machine 12 can be or is supplied with electrical energy or electric current, in particular during the motor mode of the electric machine 12. FIG. 1 particularly schematically illustrates a housing 34 of the power converter 32, the housing also being referred to as a component housing, wherein at least one or more electric or electronic parts of the power converter 32 can be accommodated in the housing 34.

In addition, the driving device 10 has at least one or precisely one heat exchanger 36, illustrated schematically in FIG. 1, around which the air conveyed by means of at least one of the blower wheels 26 can flow and through which a coolant to be cooled via the heat exchanger 36 by means of the air flowing around the heat exchanger 36 can flow, by means of which it is possible for the power converter 32 to be cooled. For example, the coolant flows through the power converter 32 and/or through a heat transfer medium which is coupled to the power converter 32 in a heat-transferring manner. As a result, heat can pass from the power converter 32 to the coolant, in particular via the heat exchanger, as a result of which the power converter 32 is cooled and the coolant is heated. The coolant can then flow to and through the heat exchanger 36. Via the heat exchanger 36, heat can pass from the coolant to the air flowing around the heat exchanger 36 and conveyed by means of at least one of the blower wheels 26, as a result of which the coolant is cooled again.

By means of the respective stream of air, for example, a respective partial region T1 or T2 of the electric machine 12 can be cooled. For example, the air flowing around the heat exchanger 36 flows to and around and/or through the partial region T2 after the air flowing around the heat exchanger 36 has flowed around the heat exchanger 36. Then, for example, heat can be transferred from the partial region T2 to the air flowing around the heat exchanger 36, as a result of which the partial region T2 is cooled.

It can be seen particularly well from FIG. 1 that the heat exchanger 36 is arranged in a closed cooling circuit 38 through which the coolant can flow. Furthermore, the driving device 10 comprises at least one or precisely one conveying element 40 which is arranged in particular in the cooling circuit 38 and by means of which the coolant can be conveyed or is conveyed through the cooling circuit 38. In this case, the conveying element 40 is arranged within the heat exchanger 36.

To convey the coolant through the cooling circuit 38, which is also referred to as the coolant circuit, the conveying element 40 is driven by the rotor 18 by means of magnetic forces and is thereby rotated about the axis of rotation 20 of the machine relative to the heat exchanger 36 and relative to the machine housing 14. For this purpose, at least one or precisely one magnet 42, designed for example as a permanent magnet, is provided, which is connected to the rotor 18, in particular to the rotor shaft 22, for rotation therewith. The magnet 42 is arranged on the rotor shaft 22, for example. The aforementioned magnetic forces for driving the conveying element 40 are provided by means of the magnet 42. The magnetic forces provided by the magnet 42 can interact with the conveying element 40 or the conveying element 40 can interact with the magnetic forces provided by the magnet 42, such that, whenever the magnet 42 is rotated together with the rotor shaft 22 about the axis of rotation 20 of the machine, the conveying element 40 is rotated at the same time with the magnet 42 via the magnetic forces. As a result, the conveying element 40 is rotated about the axis of rotation 20 of the machine, as a result of which the coolant is conveyed through the cooling circuit 38.

Since the partial regions T1 and T2 are to be or are cooled by means of the conveyed air, the electric machine 12 is air-cooled per se, that is to say is designed as an air-cooled electric machine.

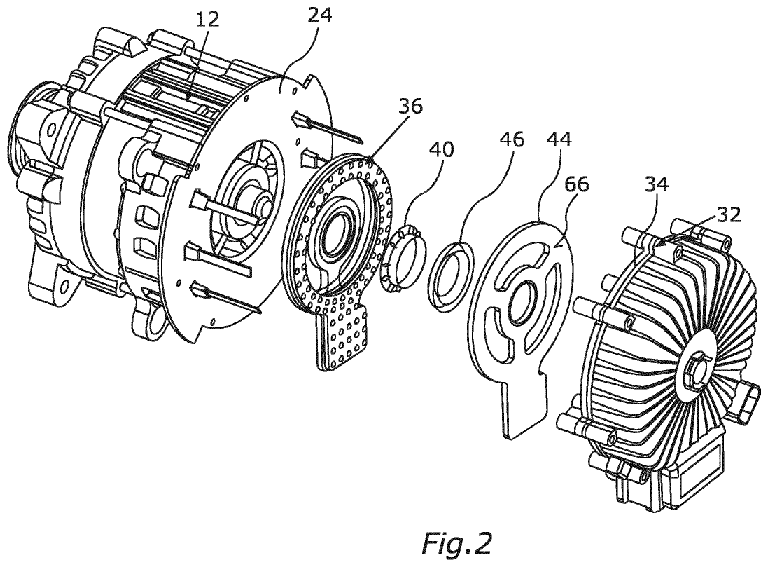

FIG. 2 shows the driving device 10 in a schematic exploded view. The heat exchanger 36 can be seen particularly well from FIG. 2. The conveying element 40, which is designed, for example, as a magnetic radial fan, can also be seen particularly well from FIG. 2. In other words, the conveying element 40 is, for example, a radial conveying element which forms a radial pump for conveying the coolant. This means that the coolant, whenever it is conveyed by means of the conveying element 40, flows away from the conveying element 40 in the radial direction thereof. The respective radial direction runs at least substantially perpendicular to the respective axial direction and thus perpendicular to the axis of rotation 20 of the machine. Furthermore, a contact element designed as a contact plate 44 and an annular channel element 46 can be seen in FIG. 2, wherein the annular channel element 46, for example, at least partially, in particular together with the contact plate 44, forms or delimits an annular channel through which the coolant can flow.

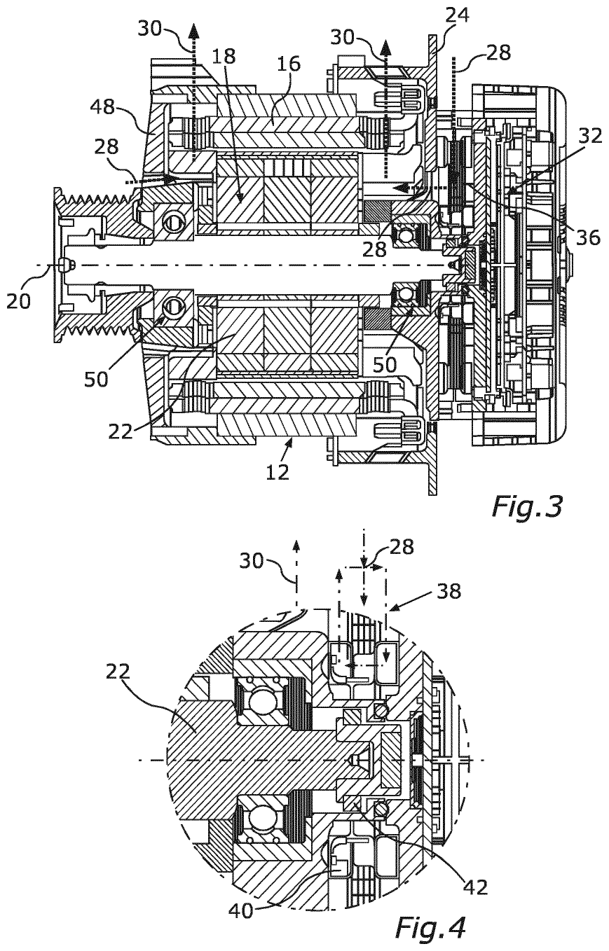

FIG. 3 shows the driving device 10 in a schematic and sectional side view. The electric machine 12 not only has the bearing plate 24, but also a second bearing plate 48 on which the rotor 18 is rotatably mounted. For this purpose, bearings 50 are provided, for example, which in the present case are designed as rolling contact bearings. The rotor 18 is mounted rotatably on the bearing plates 24 and 48 via the bearings 50.

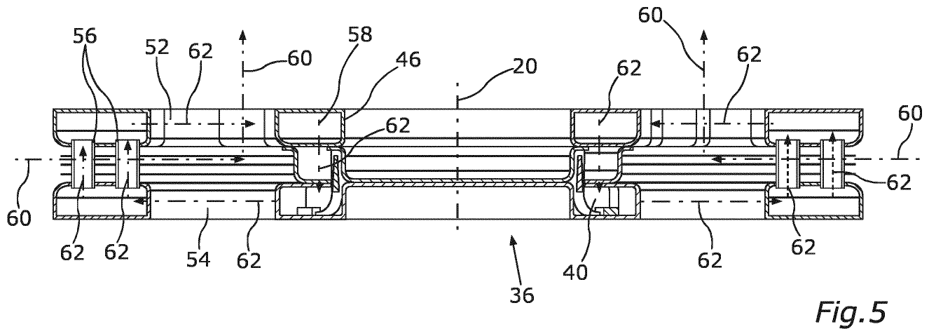

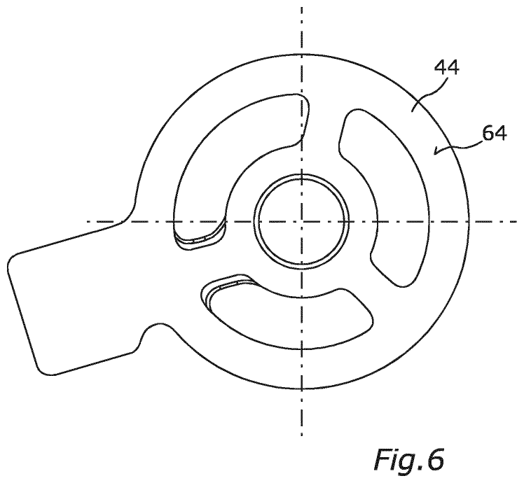

It can be seen particularly well from FIGS. 3 and 4 that the magnet 42 is designed, for example, as a ring magnet which is arranged at least indirectly on the rotor shaft 22 and, for example, is at least indirectly connected to the rotor shaft 22 for rotation therewith. FIG. 5 shows the heat exchanger 36 in a schematic sectional view. The heat exchanger 36 has at least one collecting channel 52, through which the coolant can flow, and at least one distribution channel 54, through which the coolant can flow, which channels are fluidically connected to one another, for example, at least via respective heat exchanger tubes 56, through which the coolant can flow. In addition, the annular channel which is denoted by 58 in FIG. 5, is at least partially, in particular at least predominantly, delimited by the annular channel element 46 and through which the coolant can flow can be seen. While in FIG. 5 arrows 60 illustrate the conveyed air or the flow thereof, in FIG. 5 arrows 62 illustrate the coolant flowing through the heat exchanger 36 and, in the process, through the cooling circuit 38.

The contact plate 44 which has at least two contact surfaces facing away from one another in the axial direction can be seen particularly well from FIG. 6. Of these contact surfaces, a contact surface which is denoted by 64 and faces the heat exchanger 36 can be seen in FIG. 6. The other contact surface faces the power converter 32, in particular the housing 34. While the contact surface 64 is in direct contact with the heat exchanger 36, for example, the other contact surface of the contact plate 44, that can be seen, for example, from FIG. 2 and is denoted there by 66, is in contact with the power converter 32, in particular the housing 34, directly. As a result, for example, a particularly advantageous transfer of heat, in particular by conduction, can pass via the contact plate 44 from the power converter 32, in particular from the housing 34, to the heat exchanger 36, which is cooled by means of the conveyed air. In this way, particularly effective and efficient cooling of the power converter 32 can be ensured.

In some embodiments, the coolant comprises at least or exclusively an oil or water, in particular distilled water, and therefore the coolant is also referred to, for example, as water or cooling water. Furthermore, the coolant can have at least one additive. In the case of additives for water cooling, it is not only the chemical properties that are important, but also the environmental compatibility. Ethylene glycol, which is also referred to as glycol, is suitable for this. Ethylene glycol is a dihydric alcohol with the chemical name 1,2-ethanediol. Glycol is advantageous as protection against corrosion and has a dielectric effect, which leads to a particularly advantageous transport of heat. In some embodiments, the coolant comprises at least water and glycol as additive.

Since the coolant can flow through the heat exchanger 36 and the air can flow around the latter, the heat exchanger 36 is designed as an air-liquid heat exchanger. As a result, the heat exchanger 36 can be used even at particularly extreme ambient temperatures. High amounts of heat or heat loads can be transported away in a very small space. A high degree of efficiency is achieved through a large surface area of the heat exchanger 36 and a powerful blower technology formed by the blower wheels 26.

Overall, it can be seen that, in the case of the driving device 10, air cooling of the partial regions T1 and T2 is combined with liquid cooling of the power converter 32. This results in an efficient cooling concept for the driving device 10 in its entirety and in a compact housing concept. This saves space and requires an only small outlay on maintenance. In particular, two independent consumer circuits can be realized. A first of the consumer circuits is the closed cooling circuit 38. The second consumer circuit is an air circuit through which the air can flow and which is preferably an open circuit.

The housing 34, which is also referred to as the power converter housing, is integrated, for example, into the machine housing 14, which is also referred to as the motor housing, and/or into the bearing plate 24. The power converter 32 is a power, control and regulating electronics unit or part of such a power, control and regulating electronics unit for operating, in particular for controlling or regulating, the electric machine 12.

The respective blower wheel 26 is a motor-specific blower system, since the respective blower wheel 26 can be driven by the rotor 18. Efficient cooling is of particular importance for the electric machine 12 and its components and for the parts of the power converter 32. With good cooling, for example, the service life of the electric machine 12 and the electronic parts can be extended. This can be realized with the driving device 10.

The conveying element 40, which may be a magnetic fan, enables the coolant to be thoroughly mixed and conveyed in the closed cooling circuit 38, wherein, owing to the fact that the conveying element 40 can be driven by means of the magnetic forces, a mechanical coupling of the conveying element 40 to the rotor 18 is not provided. In this way, sealing measures and the problems thereof can be avoided.

To drive the conveying element 40, for example, the magnet 42, which rotates together with the rotor shaft 22 and therefore rotates, moves the conveying element 40, which is located in the heat exchanger 36, in its magnetic field. The coolant should have a low viscosity in order not to excessively impair a connection of the conveying element 40 to the magnet 42 via the magnetic forces due to the resistance of the coolant.

### LIST OF REFERENCE SIGNS

10 Driving device
12 Electric machine
14 Machine housing
16 Stator
18 Rotor
20 Axis of rotation of the machine
22 Rotor shaft
24 Bearing plate
26 Blower wheel
28 Arrow
30 Arrow
32 Power converter
34 Housing
36 Heat exchanger
38 Cooling circuit
40 Conveying element
42 Magnet
44 Contact plate
46 Annular channel element
48 Bearing plate
50 Bearing
52 Collecting channel
54 Distributing channel
56 Heat exchanger tubes
58 Annular channel
60 Arrow
62 Arrow
64 Contact surface
66 Contact surface
T1 Partial region
T2 Partial region

What is claimed is:

1. A driving device for a motor vehicle, the device comprising:
an electric machine with a stator and a rotor driven by the stator for propelling the motor vehicle;
a blower wheel driven by the rotor to convey air for cooling at least a first portion of the electric machine;
an electric component supplying the electric machine with electrical energy; and
a heat exchanger of the blower wheel transferring heat from a coolant to the air flowing around the heat exchanger.

2. The driving device as claimed in claim 1, further comprising a closed cooling circuit providing the coolant flow through the heat exchanger.

3. The driving device as claimed in claim 1, further comprising an element for conveying the coolant.

4. The driving device as claimed in claim 3, wherein the conveying element is arranged within the heat exchanger.

5. The driving device as claimed in claim 3, wherein the conveying element is driven by the rotor without contact by means of magnetic forces and can thereby be rotated about an axis of rotation relative to the heat exchanger.

6. The driving device as claimed in claim 5, further comprising a magnet connected to the rotor for rotation therewith, providing magnetic forces for driving the conveying element.

7. The driving device as claimed in claim 1, wherein the heat exchanger is in direct contact with a housing of the component.

8. The driving device as claimed in claim 1, further comprising a contact element formed separately from the electric component and from the heat exchanger in direct contact with the heat exchanger and with a housing of the electric component.

9. The driving device as claimed in claim 1, wherein the heat exchanger is in direct contact with a bearing plate on which the rotor is rotatably mounted.

10. The driving device as claimed in claim 1, wherein the blower wheel comprising a radial blower wheel.

11. The driving device as claimed in claim 1, wherein the coolant comprises at least water and/or an oil and/or an alcohol.

12. The driving device as claimed in claim 1, wherein the electric component comprises a power converter.

13. A motor vehicle comprising:
at least one wheel;
a driving device comprising an
electric machine with a stator and a rotor driven by the stator for driving the at least one wheel; and
a blower wheel driven by the rotor to convey air for cooling a portion of the electric machine;
an electric component supplying the electric machine with electrical energy; and
a heat exchanger transferring heat to air from the blower wheel from a coolant to the electric component.
